(19) United States
(12) Patent Application Publication
(10) Pub. No.: US 2026/0089699 A1
(43) Pub. Date: Mar. 26, 2026

(54) SENSING-BASED PREDICTIVE THERMAL MANAGEMENT

(71) Applicant: QUALCOMM Incorporated, San Diego, CA (US)

(72) Inventors: Eric MATTIS, San Diego, CA (US); Fei HUANG, San Diego, CA (US); Duo ZHANG, San Diego, CA (US); Weimin DUAN, San Diego, CA (US); Dai LU, San Diego, CA (US); Pushkar Bajirao KULKARNI, San Diego, CA (US); Rongtian ZHANG, San Diego, CA (US)

(21) Appl. No.: 18/894,117

(22) Filed: Sep. 24, 2024

(51) Int. Cl. H04W 72/0453; H04W 72/50

(52) U.S. Cl. CPC H04W 72/0453; H04W 72/50

(57) ABSTRACT

Certain aspects of the present disclosure are directed towards techniques and apparatus for wireless communication at a network entity. One example method generally includes: receiving a representation of a waveform transmitted from a user equipment (UE); detecting at least one temperature prediction parameter associated with one or more transmit chains of the UE based on the received representation of the waveform; identifying a configuration of the UE to perform a signal transmission based on the at least one temperature prediction parameter; and outputting an indication of the configuration.

### TECHNICAL FIELD

Certain aspects of the present disclosure generally relate to wireless communication and, more particularly, to techniques for thermal management.

### BACKGROUND

Wireless communication devices are widely deployed to provide various communication services such as telephony, video, data, messaging, broadcasts, and so on. Such wireless communication devices may transmit and/or receive radio frequency (RF) signals via any of various suitable radio access technologies (RATs) including, but not limited to, Fifth Generation (5G) New Radio (NR), Long Term Evolution (LTE), Code Division Multiple Access (CDMA), Time Division Multiple Access (TDMA), Wideband CDMA (WCDMA), Global System for Mobility (GSM), Bluetooth, Bluetooth Low Energy (BLE), ZigBee, wireless local area network (WLAN) RATs (e.g., WiFi), and the like.

A wireless communication network may include a number of base stations that can support communication for a number of mobile stations. A mobile station (MS) may communicate with a base station (BS) via a downlink and an uplink. The downlink (or forward link) refers to the communication link from the base station to the mobile station, and the uplink (or reverse link) refers to the communication link from the mobile station to the base station. A base station may transmit data and control information on the downlink to a mobile station and/or may receive data and control information on the uplink from the mobile station. The base station and/or mobile station may include a radio implemented with a transceiver that may include a power amplifier (PA) for signal amplification.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description,” one will understand how the features of this disclosure provide advantages that include reduced power consumption.

Certain aspects of the present disclosure are directed towards a method for wireless communication at a network entity. The method generally includes: receiving a representation of a waveform transmitted from a user equipment (UE); detecting at least one temperature prediction parameter associated with one or more transmit chains of the UE based on the received representation of the waveform; identifying a configuration of the UE to perform a signal transmission based on the at least one temperature prediction parameter; and outputting an indication of the configuration.

Certain aspects of the present disclosure are directed towards a method for wireless communication at a UE. The method generally includes: transmitting a waveform via a first antenna; receiving the waveform via a second antenna; detecting at least one temperature prediction parameter associated with one or more transmit chains based on the received waveform; configuring the one or more transmit chains based on the at least one temperature prediction parameter; and performing a signal transmission via the one or more configured transmit chains.

Certain aspects of the present disclosure are directed towards an apparatus for wireless communication at a network entity. The apparatus generally includes a memory and one or more processors coupled to the memory and configured to: receive a representation of a waveform transmitted from a UE; detect at least one temperature prediction parameter associated with one or more transmit chains of the UE based on the received representation of the waveform; identify a configuration of the UE to perform a signal transmission based on the at least one temperature prediction parameter; and output an indication of the configuration.

Certain aspects of the present disclosure are directed towards an apparatus for wireless communication. The apparatus generally includes a memory and one or more processors configured to: transmit a waveform via a first antenna; receiving the waveform via a second antenna; detect at least one temperature prediction parameter associated with one or more transmit chains based on the received waveform; configure the one or more transmit chains based on the at least one temperature prediction parameter; and perform a signal transmission via the one or more configured transmit chains.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram of an example wireless communications network, in which aspects of the present disclosure may be practiced.

FIG. 2 is a block diagram conceptually illustrating a design of an example base station (BS) and user equipment (UE), in which aspects of the present disclosure may be practiced.

FIG. 3 is a block diagram of an example radio frequency (RF) transceiver, in which aspects of the present disclosure may be practiced.

FIG. 4 illustrates a transceiver with a loopback path for object detection and ranging.

FIG. 5 illustrates components of a server for heating prediction, in accordance with certain aspects of the present disclosure.

FIG. 6 illustrates communication devices including a server controlling multiple base stations for thermal management, in accordance with certain aspects of the present disclosure.

FIG. 7 is a flow diagram illustrating example operations for wireless communication at a network entity, in accordance with certain aspects of the present disclosure.

FIG. 8 is a flow diagram illustrating example operations for wireless communication at a UE, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure are directed toward techniques for thermal management in a predictive manner. For example, a device may transmit signals using a power amplifier (PA), causing heating. In some aspects, a non-linearity of the PA may be detected and used to predict the heating of the PA during a future data transmission. If the temperature of the PA is expected to increase above a threshold, the configuration for the signal transmission may be preemptively adjusted to reduce the heating of the PA before the signal transmission. In some aspects, to identify the non-linearity of the PA for the device, the device may transmit a waveform that may be received and analyzed by the device itself (e.g., a user equipment (UE)) or by one or more network entities (e.g., received by a base station and analyzed by a network server). In some aspects, the waveform used for PA non-linearity detection may be orthogonal with a waveform used for user data transmissions, allowing the waveform transmission for PA non-linearity to be performed along with the user data transmissions. In some cases, a UE may transmit the waveform and process a reflected signal corresponding to the waveform to determine whether a temperature of a PA that transmitted the reflected signal is outside of a nominal operating range.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### An Example Wireless System

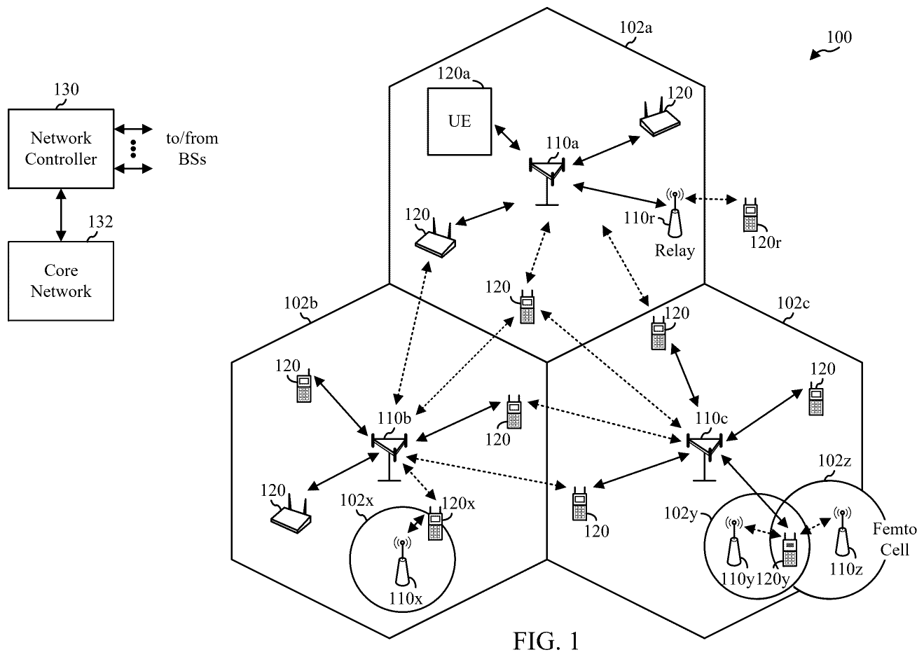

FIG. 1 illustrates an example wireless communications network 100, in which aspects of the present disclosure may be practiced. For example, the wireless communications network 100 may be a New Radio (NR) system (e.g., a Fifth Generation (5G) NR network), an Evolved Universal Terrestrial Radio Access (E-UTRA) system (e.g., a Fourth Generation (4G) network), a Universal Mobile Telecommunications System (UMTS) (e.g., a Second Generation/Third Generation (2G/3G) network), or a code division multiple access (CDMA) system (e.g., a 2G/3G network), or may be configured for communications according to an IEEE standard such as one or more of the 802.11 standards, etc.

As illustrated in FIG. 1, the wireless communications network 100 may include a number of base stations (BSs) 110a-z (each also individually referred to herein as “BS 110” or collectively as “BSs 110”) and other network entities. A BS may also be referred to as an access point (AP), an evolved Node B (eNodeB or eNB), a next generation Node B (gNodeB or gNB), or some other terminology.

A BS 110 may provide communication coverage for a particular geographic area, sometimes referred to as a “cell,” which may be stationary or may move according to the location of a mobile BS. In some examples, the BSs 110 may be interconnected to one another and/or to one or more other BSs or network nodes (not shown) in wireless communications network 100 through various types of backhaul interfaces (e.g., a direct physical connection, a wireless connection, a virtual network, or the like) using any suitable transport network. In the example shown in FIG. 1, the BSs 110a, 110b, and 110c may be macro BSs for the macro cells 102a, 102b, and 102c, respectively. The BS 110x may be a pico BS for a pico cell 102x. The BSs 110y and 110z may be femto BSs for the femto cells 102y and 102z, respectively. A BS may support one or multiple cells.

The BSs 110 communicate with one or more user equipment's (UEs) 120a-y (each also individually referred to herein as “UE 120” or collectively as “UEs 120”) in the wireless communications network 100. A UE may be fixed or mobile and may also be referred to as a user terminal (UT), a mobile station (MS), an access terminal, a station (STA), a client, a wireless device, a mobile device, or some other terminology. A user terminal may be a wireless device, such as a cellular phone, a smartphone, a personal digital assistant (PDA), a handheld device, a wearable device, a wireless modem, a laptop computer, a tablet, a personal computer, etc.

The BSs 110 are considered transmitting entities for the downlink and receiving entities for the uplink. The UEs 120 are considered transmitting entities for the uplink and receiving entities for the downlink. As used herein, a “transmitting entity” is an independently operated apparatus or device capable of transmitting data via a frequency channel, and a “receiving entity” is an independently operated apparatus or device capable of receiving data via a frequency channel. In the following description, the subscript “dn” denotes the downlink, the subscript “up” denotes the uplink. Nᵤₚ UEs may be selected for simultaneous transmission on the uplink, N_{dn} UEs may be selected for simultaneous transmission on the downlink. Nᵤₚ may or may not be equal to N_{dn}, and Nᵤₚ and N_{dn} may be static values or can change for each scheduling interval. Beam-steering or some other spatial processing technique may be used at the BSs 110 and/or UEs 120.

The UEs 120 (e.g., 120x, 120y, etc.) may be dispersed throughout the wireless communications network 100, and each UE 120 may be stationary or mobile. The wireless communications network 100 may also include relay stations (e.g., relay station 110r), also referred to as relays or the like, that receive a transmission of data and/or other information from an upstream station (e.g., a BS 110a or a UE 120r) and send a transmission of the data and/or other information to a downstream station (e.g., a UE 120 or a BS 110), or that relays transmissions between UEs 120, to facilitate communication between devices.

The BSs 110 may communicate with one or more UEs 120 at any given moment on the downlink and uplink. The downlink (i.e., forward link) is the communication link from the BSs 110 to the UEs 120, and the uplink (i.e., reverse link) is the communication link from the UEs 120 to the BSs 110. A UE 120 may also communicate peer-to-peer with another UE 120.

The wireless communications network 100 may use multiple transmit and multiple receive antennas for data transmission on the downlink and uplink. BSs 110 may be equipped with a number Nₐₚ of antennas to achieve transmit diversity for downlink transmissions and/or receive diversity for uplink transmissions. A set Nᵤ of UEs 120 may receive downlink transmissions and transmit uplink transmissions. Each UE 120 may transmit user-specific data to and/or receive user-specific data from the BSs 110. In general, each UE 120 may be equipped with one or multiple antennas. The Nᵤ UEs 120 can have the same or different numbers of antennas.

The wireless communications network 100 may be a time division duplex (TDD) system or a frequency division duplex (FDD) system. For a TDD system, the downlink and uplink share the same frequency band. For an FDD system, the downlink and uplink use different frequency bands. The wireless communications network 100 may also utilize a single carrier or multiple carriers for transmission. Each UE 120 may be equipped with a single antenna (e.g., to keep costs down) or multiple antennas (e.g., where the additional cost can be supported).

A network controller 130 (also sometimes referred to as a “system controller”) may be in communication with a set of BSs 110 and provide coordination and control for these BSs 110 (e.g., via a backhaul). In certain cases (e.g., in a 5G NR system), the network controller 130 may include a centralized unit (CU) and/or a distributed unit (DU). In certain aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

In certain aspects of the present disclosure, the BSs 110 and/or the UEs 120 may be configured to detect non-linearity associated with one or more amplifiers for thermal management, in accordance with certain aspects of the present disclosure.

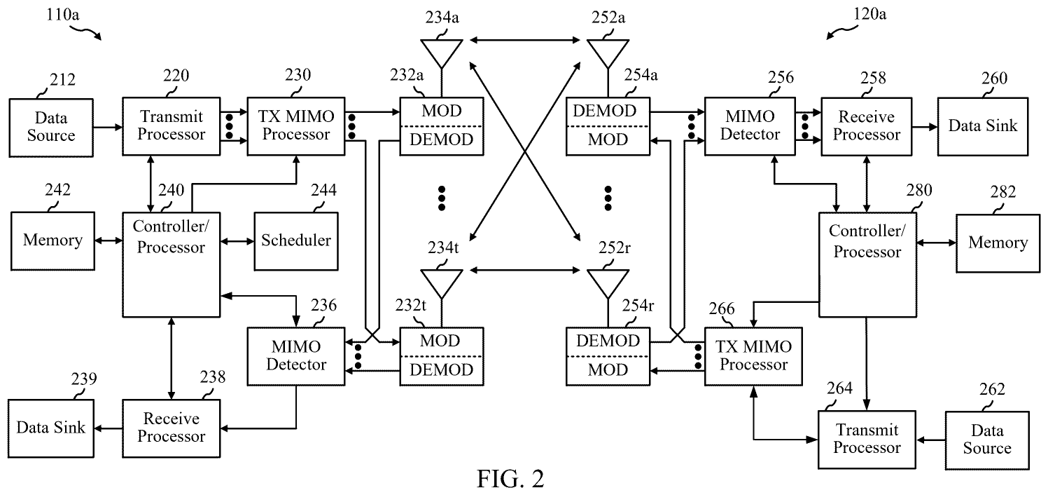

FIG. 2 illustrates example components of BS 110a and UE 120a (e.g., from the wireless communications network 100 of FIG. 1), in which aspects of the present disclosure may be implemented.

On the downlink, at the BS 110a, a transmit processor 220 may receive data from a data source 212, control information from a controller/processor 240, and/or possibly other data (e.g., from a scheduler 244). The various types of data may be sent on different transport channels. For example, the control information may be designated for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), etc. The data may be designated for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a PDSCH, a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS).

A transmit (TX) multiple-input, multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232tmay process a respective output symbol stream (e.g., for orthogonal frequency division multiplexing (OFDM), etc.) to obtain an output sample stream. Each of the transceivers 232a-232t may further process (e.g., convert to analog, amplify, filter, and upconvert) the output sample stream to obtain a downlink signal. Downlink signals from the transceivers 232a-232t may be transmitted via the antennas 234a-234t, respectively.

At the UE 120a, the antennas 252a-252r may receive the downlink signals from the BS 110a and may provide received signals to the transceivers 254a-254r, respectively. The transceivers 254a-254r may condition (e.g., filter, amplify, downconvert, and digitize) a respective received signal to obtain input samples. Each demodulator (DEMOD) in the transceivers 232a-232t may further process the input samples (e.g., for OFDM, etc.) to obtain received symbols. A MIMO detector 256 may obtain received symbols from all the demodulators in transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH)) from the controller/processor 280. The transmit processor 264 may also generate reference symbols for a reference signal (e.g., the sounding reference signal (SRS)). The symbols from the transmit processor 264 may be precoded by a TX MIMO processor 266 if applicable, further processed by the modulators (MODs) in transceivers 254a-254r (e.g., for single-carrier frequency division multiplexing (SC-FDM), etc.), and transmitted to the BS 110a. At the BS 110a, the uplink signals from the UE 120a may be received by the antennas 234, processed by the demodulators in transceivers 232a-232t, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. The memories 242 and 282 may also interface with the controllers/processors 240 and 280, respectively. A scheduler 244 may schedule UEs for data transmission on the downlink and/or uplink.

In certain aspects of the present disclosure, the transceivers 232 and/or the transceivers 254 may be configured to detect non-linearity associated with one or more amplifiers for thermal management, in accordance with certain aspects of the present disclosure.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The system bandwidth may also be partitioned into subbands. For example, a subband may cover multiple resource blocks (RBs).

### Example RF Transceiver

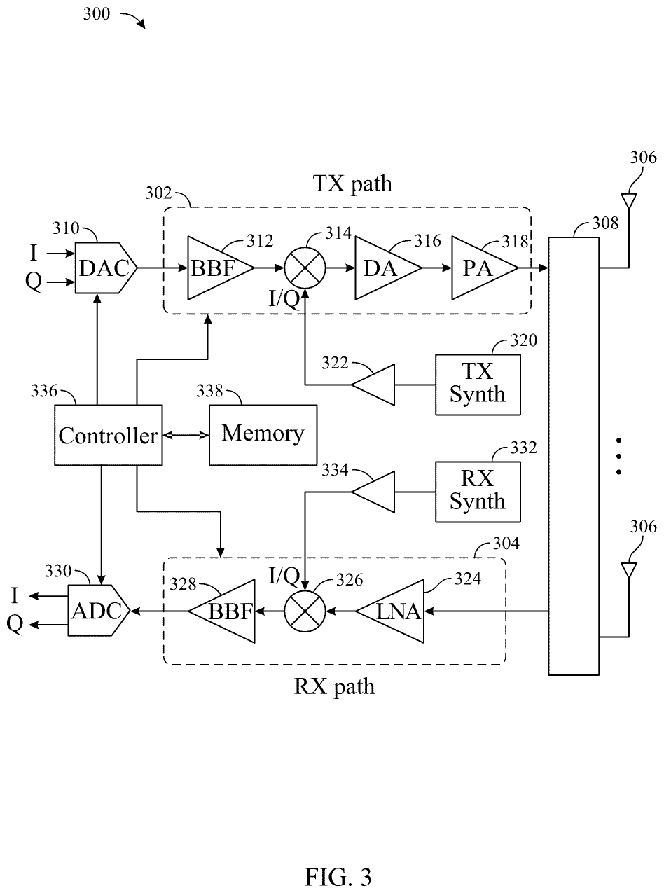

FIG. 3 is a block diagram of an example radio frequency (RF) transceiver circuit 300, in accordance with certain aspects of the present disclosure. The RF transceiver circuit 300 includes at least one transmit (TX) path 302 (also known as a “transmit chain”) for transmitting signals via one or more antennas 306 and at least one receive (RX) path 304 (also known as a “receive chain”) for receiving signals via the antennas 306. When the TX path 302 and the RX path 304 share an antenna 306, the paths may be connected with the antenna via an interface 308, which may include any of various suitable RF devices, such as a switch, a duplexer, a diplexer, a multiplexer, and the like.

Receiving in-phase (I) and/or quadrature (Q) baseband analog signals from a digital-to-analog converter (DAC) 310, the TX path 302 may include a baseband filter (BBF) 312, a mixer 314, a driver amplifier (DA) 316, and a power amplifier (PA) 318. The BBF 312, the mixer 314, the DA 316, and the PA 318 may be included in a radio frequency integrated circuit (RFIC). For certain aspects, the PA 318 may be external to the RFIC.

The BBF 312 filters the baseband signals received from the DAC 310, and the mixer 314 mixes the filtered baseband signals with a transmit local oscillator (LO) signal to convert the baseband signal of interest to a different frequency (e.g., upconvert from baseband to a radio frequency). This frequency-conversion process produces the sum and difference frequencies between the LO frequency and the frequencies of the baseband signal of interest. The sum and difference frequencies are referred to as the “beat frequencies.” The beat frequencies are typically in the RF range, such that the signals output by the mixer 314 are typically RF signals, which may be amplified by the DA 316 and/or by the PA 318 before transmission by the antenna(s) 306. In some aspects, a non-linearity associated with the PA 318 may be detected for predictive thermal management, as described in more detail herein. While one mixer 314 is illustrated, several mixers may be used to upconvert the filtered baseband signals to one or more intermediate frequencies and to thereafter upconvert the intermediate frequency (IF) signals to a frequency for transmission.

The RX path 304 may include a low noise amplifier (LNA) 324, a mixer 326, and a baseband filter (BBF) 328. The LNA 324, the mixer 326, and the BBF 328 may be included in one or more RFICs, which may or may not be the same RFIC that includes the TX path components. RF signals received via the antenna(s) 306 may be amplified by the LNA 324, and the mixer 326 mixes the amplified RF signals with a receive local oscillator (LO) signal to convert the RF signal of interest to a different baseband frequency (e.g., downconvert). The baseband signals output by the mixer 326 may be filtered by the BBF 328 before being converted by an analog-to-digital converter (ADC) 330 to digital I and/or Q signals for digital signal processing.

Certain transceivers may employ frequency synthesizers with a variable-frequency oscillator (e.g., a voltage-controlled oscillator (VCO) or a digitally controlled oscillator (DCO)) to generate a stable, tunable LO with a particular tuning range. Thus, the transmit LO may be produced by a TX frequency synthesizer 320, which may be buffered or amplified by amplifier 322 before being mixed with the baseband signals in the mixer 314. Similarly, the receive LO may be produced by an RX frequency synthesizer 332, which may be buffered or amplified by amplifier 334 before being mixed with the RF signals in the mixer 326. For certain aspects, a single frequency synthesizer may be used for both the TX path 302 and the RX path 304. In certain aspects, the TX frequency synthesizer 320 and/or RX frequency synthesizer 332 may include a frequency divider/multiplier that is driven by an oscillator (e.g., a VCO) in the frequency synthesizer.

A controller 336 (e.g., controller/processor 280 in FIG. 2) may direct the operation of the RF transceiver circuit 300A, such as transmitting signals via the TX path 302 and/or receiving signals via the RX path 304. The controller 336 may be a processor, a digital signal processor (DSP), an application-specific integrated circuit (ASIC), a field-programmable gate array (FPGA) or other programmable logic device (PLD), discrete gate or transistor logic, discrete hardware components, or any combination thereof. A memory 338 (e.g., memory 282 in FIG. 2) may store data and/or program codes for operating the RF transceiver circuit 300. The controller 336 and/or the memory 338 may include control logic (e.g., complementary metal-oxide-semiconductor (CMOS) logic).

While FIGS. 1-3 provide wireless communications as an example application in which certain aspects of the present disclosure may be implemented to facilitate understanding, certain aspects described herein may be used for any of various other suitable systems.

### Techniques for Thermal Management

Radio frequency (RF) sensing is being adopted in some implementations. RF sensing involves RF transmissions to sense the presence of objects near a wireless device. Wide area RF sensing use cases involve high transmission power from a transmitter (Tx), which may result in a power amplifier (PA) of the wireless device overheating. Some networks allocate time and frequency resources for RF sensing (e.g., wideband and periodical resources for RF sensing). For example, ultra-wideband sensing resources may be used to achieve high-resolution range estimation. RF sensing resources can be transmitted with long time spans for high-resolution target speed estimation.

Some aspects are directed towards early detection of PA overheating, allowing preemptive measures to be taken to reduce the PA heating. Some RF sensing techniques involve predicting a worst-case PA operation scenario in terms of overheating, based on which overheating may be avoided preemptively by adjusting communication configurations such as transmit power, bandwidth, and/or periodicity. The high transmission power and substantial time and/or frequency resources may result in overheating in some environments. Full duplex mono-static RF sensing use cases may be most challenging for PA operations with regard to overheating.

A frequency-modulated continuous wave (FMCW) may be used for RF sensing in some implementations. FMCW is a form of radar signal in which the frequency of the transmitted signal may be continuously varied at a known rate over a defined time period. The reflected frequency signal may be received and compared to the transmitted FMCW signal. The reflection of the FMCW signal may be a chirped signal (e.g., a signal having a varying frequency). The reflection signal may be de-chirped. FMCW radars may estimate a target range using the beat frequency embedded in the de-chirped signal. The radar may use the maximum beat frequency for object detection, which may be the sum of the beat frequency corresponding to a maximum range and a maximum Doppler frequency.

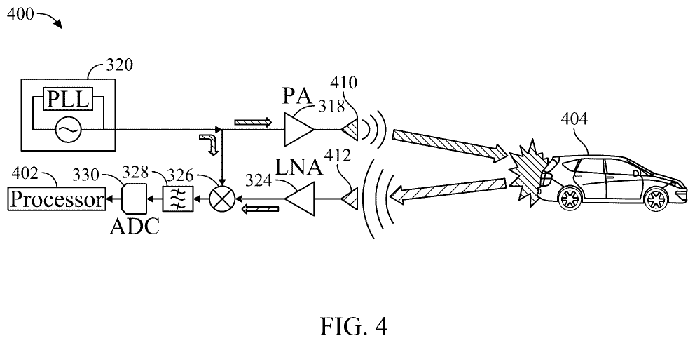

FIG. 4 illustrates a transceiver 400 with a loopback path for object detection and ranging. The transceiver 400 may generate an FMCW signal for radar operations. As shown, the frequency synthesizer (e.g., implemented with a phased-locked loop (PLL)) may generate an FMCW signal that may be amplified via PA 318 (potentially after being upconverted) and transmitted via antenna 410. The FMCW signal may reflect from an object 404. The reflected signal may be received via antenna 412, amplified via LNA 324, and effectively compared with the FMCW signal from the loopback path using the mixer 326, as shown. The output signal of the mixer may be processed via filter 328 to generate a filtered signal that is converted to a digital signal via an ADC 330. The digital signal may be processed using a processor 402 for object detection and ranging, for example. The hardware (e.g., transceiver 400) may be shared for both data communications and sensing operations. In some aspects of the present disclosure, the transceiver 400 may be used to transmit a waveform for PA non-linearity detection, as described in more detail herein.

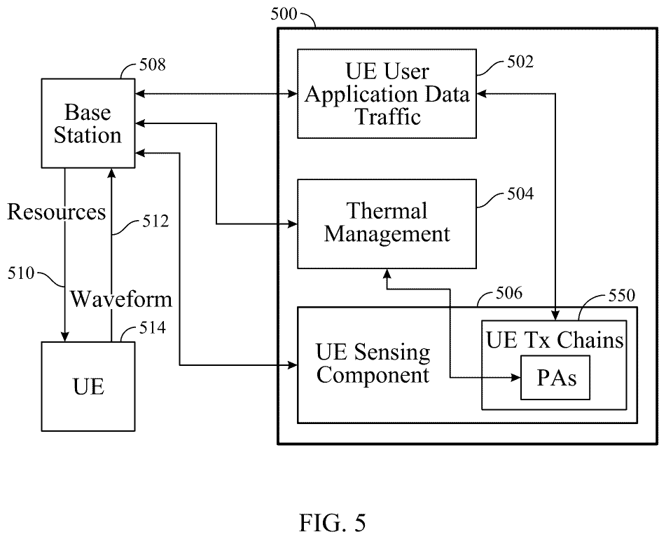

FIG. 5 illustrates components of a server 500 for heating prediction, in accordance with certain aspects of the present disclosure. While some examples describe thermal management being at a server, the thermal management techniques described herein may be performed by any suitable entity, such as a UE or a base station. As shown, the server 500 may include a UE user application data traffic component 502 that may be used to manage application data traffic for a UE. The server 500 may also include a sensing-based thermal management component 504 that may be used for thermal management in an attempt to reduce the heating of one or more transmit chains (e.g., PAs) of a UE. The server 500 may also include a UE sensing component 506 that may be used to predict the heating of one or more Tx chains of a UE 514. For example, as described in more detail herein, the UE sensing component 506 may include a digital twin 550 representing one or more Tx chains of a UE such as the UE 514. The UE sensing component 506 may be implemented using one or more processors. Each of the Tx chains may include a PA such as the PA 318 shown in FIGS. 3 and 4. The digital twin 550 may be used to predict the heating of the Tx chains of the UE in response to future transmissions. The digital twin may be digital logic configured to simulate the thermal behavior of a PA and/or other portions of each of one or more Tx chains. The data traffic component 502, the thermal management component 504, and UE sensing component 506 may be communicably coupled to a base station 508. The base station 508 may be used for resource scheduling for a UE 514.

For sensing-based thermal management, the UE may transmit a specific radio waveform based on a sensing resource configuration from the base station 508. For example, the base station 508 may send a resource allocation 510 to the UE 514 for allocation of resources by the UE. Using the allocated resources, the UE 514 may transmit a waveform 512 that may be received by the base station 508. The waveform 512 may be an orthogonal frequency-division multiplexing (OFDM), FMCW signal, or any other suitable waveform for detecting PA non-linearity. The waveform may be used to detect the non-linearity associated with the UE 514 (e.g., a non-linearity associated with a PA of the UE 514). In some cases, the resources may be allocated (e.g., scheduled) by the base station 508 based on input from the data traffic component 502. The data traffic component 502 may manage the data traffic between the base station and the UE.

In some aspects, to detect the PA non-linearity, the thermal management component 504 may receive the waveform from the base station 508 and detect the non-linearity associated with the UE based on the waveform. The result of the detection may be used to predict overheating before future user data traffic or RF sensing transmission. With higher temperatures of the PA, the PA non-linearity increases. Based on the PA non-linearity, the thermal management component 504 may predict overheating (e.g., based on input from the UE sensing component 506) and preemptively take preventive measures to avoid future overheating. In some aspects, the preventive measures may include, but are not limited to, an adjustment of duty cycle (e.g., reduction of the duty cycle for transmissions to reduce PA heating), adjustment of bandwidth (e.g., reduction of bandwidth to reduce PA heating), backing off transmit power (e.g., reducing transmit power), and/or switching PAs (e.g., switching between PAs during transmissions to reduce overall PA heating).

In some aspects, the techniques described herein may coexist with data/control traffic. For example, when user traffic is ongoing, the UE may simultaneously facilitate the prediction of future temperatures to avoid overheating because base station 508 (e.g., scheduler) may allocate orthogonal resources for the sensing and user traffic. In other words, a waveform for PA non-linearity detection may be transmitted simultaneously with user traffic. If a future temperature increase above a threshold is predicted, the server 500 may control the base station 508 to adjust one or more transmission configurations (e.g., duty cycle, bandwidth, and/or transmit power) in an attempt to reduce the average power consumption and heating of the UE Tx chains.

As described, the UE sensing component 506 may be implemented with a digital twin 550 of the UE 514 (e.g., a digital twin of UE Tx chains including respective PAs). The digital twin may be implemented based on analysis of the waveform transmitted from the UE. The digital twin may represent the non-linearity associated with one or more PAs of the UE and may be used to predict the heating of the UE Tx chains for preemptive measures.

The timing for the UE to transmit the radio waveform 512 may be scheduled by the base station 508. The waveform 512 may be transmitted periodically, lasting for a time duration that may be scheduled by the base station 508. In other aspects, the waveform 512 may be transmitted intermittently. The waveform may be sent via the UE Tx chains. The waveform may be captured by the base station 508 and communicated to the UE sensing component 506 for analysis and identification of PA non-linearity. When PA non-linearity is detected (e.g., after the fast-Fourier transform (FFT) of the waveform 512), the over-heating trend is detected and used for future scheduling.

While in some examples provided herein, the waveform 512 may be received via the base station 508 and analyzed at the network side (e.g., server 500), in some aspects, the waveform transmitted by the UE may be received via a receiving circuit of the UE itself and analyzed. For instance, referring back to FIG. 4, the waveform may be amplified via PA 318 and transmitted via antenna 410. The waveform may be received via antenna 412. The received waveform may be amplified via LNA 324, down-converted via mixer 326, filtered via filter 328, and converted to a digital signal via ADC 330. The digital signal may be processed via the processor 402 to detect the non-linearity of the PA 318.

The results of the analysis (e.g., non-linearity of the UE PAs) may be used to configure future transmissions to reduce heating. For instance, the non-linearity of the UE PAs may be indicated to the server 500 to be used for temperature prediction when allocating resources for RF sensing and data communication.

The preemptive non-linearity detection techniques described herein facilitate the reduction of overheating for user data transmissions. The hardware for the transmission of the waveform for the non-linearity detection may be shared and also used for the transmission of user data. Hardware sharing between sensing and communications may be implemented so that the overhead associated with the non-linearity detection is mostly software changes on existing platforms, reducing complicated and expensive circuit re-designs.

Some thermal management techniques use PA non-linearity to derive temperature and/or use sensors to measure temperature, both of which rely on uplink user traffic. Whenever no uplink data traffic exists, such implementation may be unable to detect non-linearity. Some aspects of the present disclosure use allocated sensing resources (e.g., frequency bands, times, and antennas that are dedicatedly allocated for RF sensing) for PA non-linearity detection. By using the sensing resources to regularly (e.g., periodically) transmit one of the aforementioned waveforms, PA non-linearity may be detected even when no uplink data traffic exists. In some cases, the UE may receive the UE's own transmitted waveform, analyze the waveform, and detect the PA non-linearity to predict that overheating will happen for the user traffic, as described. Thus, one or more preemptive measures to avoid overheating may be taken before uplink user traffic begins to reduce overheating. The thermal management techniques described herein facilitate non-linearity detection in a regular (e.g., periodic) manner.

Some implementations use PA non-linearity to derive UE temperatures in a passive manner. The techniques described herein use sensing resources that may be dedicatedly allocated by the network (e.g., for RF sensing) to perform non-linearity detection. Future uplink user traffic may be known and allocated by the network. Therefore, the network may be aware of both the sensing resources and the future uplink user traffic, allowing the network to predict and schedule the sensing and traffic resources in an orthogonal manner so that the waveform for non-linearity detection can be transmitted along with the user traffic. The network may notify the UE to perform sensing-based thermal management before the user traffic begins. Furthermore, the network may notify the UE to match at least a portion of the configuration for the sensing-based thermal management with the user traffic. For instance, the radio waveform for the purpose of sensing PA non-linearity may be scheduled for transmission/reception on the same frequency bands and using the same Tx/Rx antennas as the future uplink user traffic to provide a more accurate estimate of heating during the user traffic. For sensing non-linearity, one of the candidate waveforms provided by current standards, such as FMCW or OFDM, may be used.

As described, in some cases, the sensing-based thermal management may be performed by components residing in a server. The server may control and coordinate multiple base stations (e.g., next-generation node Bs (gNBs)), where each base station follows the server's control to perform sensing-based thermal management.

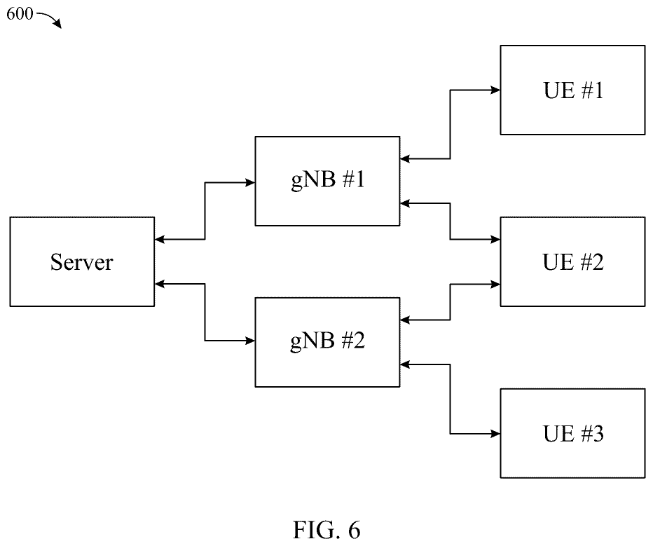

FIG. 6 illustrates communication devices 600 including a server controlling multiple base stations for thermal management, in accordance with certain aspects of the present disclosure. As shown, the server may control base stations (e.g., labeled “gNB #1,” “gNB #2,” and “gNB #3”), which may serve UEs (e.g., labeled “UE #1,” “UE #2,” and “UE #3”). UE #2 may be on the cell edge (e.g., edge of the cell served by gNB #1), located between gNB #1 (service cell) and gNB #2 (adjacent cell). The server may include the sensing-based thermal management component 504 of FIG. 5. Based on sensing the UE transmitted waveform, the thermal management component 504 may predict UE #2 will overheat during future data traffic. The thermal management component 504 may notify UE #2 (e.g., through gNB #1 or base station 508) to back off the PAs to reduce transmit power and the likelihood of overheating, albeit at the cost of lower throughput or lower quality of service (QoS).

In some aspects, to at least partially compensate for the lower QoS, the thermal management component 504 may notify the adjacent cell (gNB #2) to allocate resources to receive the uplink data from UE #2, providing uplink diversity that at least partially compensates for the lower QoS. In other words, the uplink data from UE #2 may be received by gNB #1 and gNB #2 and combined for decoding via a backend link, increasing the QoS.

In some cases, to identify non-linearity, a series of non-linear equations may be solved. In some aspects, artificial intelligence (AI) may be used to solve non-linear equations with the fewest iterations and reduce computational time. The AI may be implemented as part of the thermal management component 504 (or as part of processor 402) to solve a system of non-linear equations in real time or using a regression function to PA non-linearity detection.

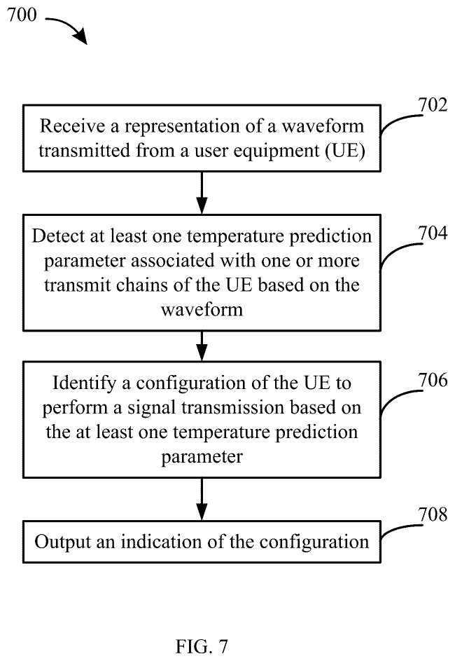

FIG. 7 is a flow diagram illustrating example operations 700 for wireless communication, in accordance with certain aspects of the present disclosure. The operations 700 may be performed, for example, by a processing device of a network entity, such as the controller 240 of BS 110, or one or more components of a server such as the thermal management component 504 of the server 500.

At block 702, the processing device receives a representation of a waveform transmitted from a UE. The waveform may include a frequency-modulated continuous wave (FMCW) waveform or an orthogonal frequency-division multiplexing (OFDM) waveform. In some aspects, the waveform may be orthogonal with a waveform for communication traffic from the UE. In some aspects, the processing device may allocate one or more resources for the transmission of the waveform.

At block 704, the processing device detects at least one temperature prediction parameter associated with one or more transmit chains of the UE based on the waveform. In some aspects, the at least one temperature prediction parameter may include a parameter indicating a non-linearity associated with one or more amplifiers of the one or more transmit chains. In some aspects, detecting the at least one temperature prediction parameter comprises solving one or more non-linear equations to identify a non-linearity associated with the one or more transmit chains using artificial intelligence (AI).

At block 706, the processing device identifies a configuration of the UE to perform a signal transmission (e.g., transmission of user traffic) based on the at least one temperature prediction parameter. Configuring the UE may include allocating one or more resources to the UE to perform the signal transmission. In some aspects, the processing device predicts a temperature associated with the one or more transmit chains based on the at least one temperature prediction parameter. The configuration may be identified based on the prediction of the temperature.

In some aspects, the processing device may configure a digital twin representing the one or more transmit chains of the UE based on the at least one temperature prediction parameter. The temperature associated with the one or more transmit chains when the waveform was being transmitted is predicted using the digital twin.

In some aspects, identifying the configuration may include at least one of identifying a duty cycle associated with the signal transmission, identifying a bandwidth associated with the signal transmission, identifying a transmission power associated with the signal transmission, or selecting an amplifier to be used for the signal transmission.

At block 708, the processing device may output an indication of the configuration. For example, the processing device may control a base station to configure a UE to perform the signal transmission in accordance with the configuration. In some aspects, the processing device may configure a first base station (e.g., gNB #1) and a second base station (e.g., gNB #2) to receive the signal transmission based on the configuration of the UE.

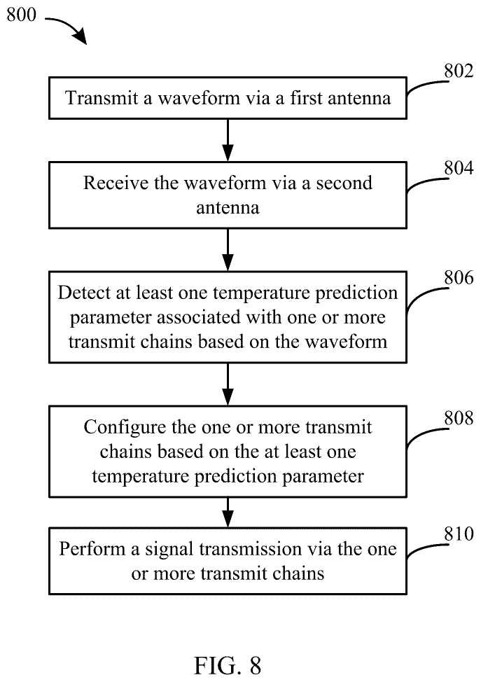

FIG. 8 is a flow diagram illustrating example operations 800 for wireless communication, in accordance with certain aspects of the present disclosure. The operations 800 may be performed, for example, by a UE, such as the UE 120 that may include the transceiver 400.

At block 802, the UE transmits a waveform via a first antenna (e.g., antenna 410 of FIG. 4). The waveform includes a frequency-modulated continuous wave (FMCW) waveform or an orthogonal frequency-division multiplexing (OFDM) waveform. The waveform is orthogonal with a waveform for communication traffic from the UE. In some aspects, the UE may receive an allocation of one or more resources for the transmission of the waveform. The waveform may be transmitted via the one or more resources. At block 804, the UE receives the waveform via a second antenna (e.g., antenna 412 of FIG. 4).

At block 806, the UE detects at least one temperature prediction parameter associated with one or more transmit chains based on the received waveform. The at least one temperature prediction parameter may include a parameter indicating a non-linearity associated with one or more amplifiers of the one or more transmit chains. Detecting the at least one temperature prediction parameter may include solving one or more non-linear equations to identify a non-linearity associated with the one or more transmit chains using a trained machine learning model.

In some aspects, the UE may predict a temperature associated with the one or more transmit chains when performing the signal transmission based on the at least one temperature prediction parameter. The one or more transmit chains may be configured based on the predicted temperature.

At block 808, the UE configures the one or more transmit chains based on the at least one temperature prediction parameter. At block 810, the UE performs a signal transmission via the one or more configured transmit chains. Configuring the one or more transmit chains may include at least one of configuring a duty cycle associated with the signal transmission, configuring a bandwidth associated with the signal transmission, configuring a transmission power associated with the signal transmission, or selecting an amplifier to be used for the signal transmission.

### Example Aspects

In addition to the various aspects described above, specific combinations of aspects are within the scope of the present disclosure, some of which are detailed below:

Aspect 1: A method for wireless communication at a network entity, comprising: receiving a representation of a waveform transmitted from a user equipment (UE); detecting at least one temperature prediction parameter associated with one or more transmit chains of the UE based on the received representation of the waveform; identifying a configuration of the UE to perform a signal transmission based on the at least one temperature prediction parameter; and outputting an indication of the configuration.

Aspect 2: The method of Aspect 1, wherein identifying the configuration of the UE comprises allocating one or more resources to the UE to perform the signal transmission.

Aspect 3: The method of Aspect 1 or 2, wherein the waveform includes a frequency-modulated continuous wave (FMCW) waveform or an orthogonal frequency-division multiplexing (OFDM) waveform.

Aspect 4: The method according to any of Aspects 1-3, wherein the at least one temperature prediction parameter comprises a parameter indicating a non-linearity associated with one or more amplifiers of the one or more transmit chains.

Aspect 5: The method according to any of Aspects 1-4, further comprising predicting a temperature associated with the one or more transmit chains based on the at least one temperature prediction parameter, wherein the configuration is identified based on the predicted temperature.

Aspect 6: The method of Aspect 5, further comprising configuring a digital twin representing the one or more transmit chains of the UE based on the at least one temperature prediction parameter, wherein the temperature associated with the one or more transmit chains when the waveform was being transmitted is predicted using the digital twin.

Aspect 7: The method according to any of Aspects 1-6, wherein identifying the configuration comprises at least one of identifying a duty cycle associated with the signal transmission, identifying a bandwidth associated with the signal transmission, identifying a transmission power associated with the signal transmission, or selecting an amplifier to be used for the signal transmission.

Aspect 8: The method according to any of Aspects 1-7, wherein the waveform is orthogonal with a waveform for communication traffic from the UE.

Aspect 9: The method according to any of Aspects 1-8, further comprising allocating one or more resources for transmitting the waveform.

Aspect 10: The method according to any of Aspects 1-9, further comprising configuring a first base station and a second base station to receive the signal transmission based on the configuration of the UE.

Aspect 11: The method according to any of Aspects 1-10, wherein detecting the at least one temperature prediction parameter comprises solving one or more non-linear equations to identify a non-linearity associated with the one or more transmit chains using a trained machine learning model.

Aspect 12: A method for wireless communication at a user equipment (UE), comprising: transmitting a waveform via a first antenna; receiving the waveform via a second antenna; detecting at least one temperature prediction parameter associated with one or more transmit chains based on the received waveform; configuring the one or more transmit chains based on the at least one temperature prediction parameter; and performing a signal transmission via the one or more configured transmit chains.

Aspect 13: The method of Aspect 12, wherein the waveform includes a frequency-modulated continuous wave (FMCW) waveform or an orthogonal frequency-division multiplexing (OFDM) waveform.

Aspect 14: The method of Aspect 12 or 13, wherein the at least one temperature prediction parameter comprises a parameter indicating a non-linearity associated with one or more amplifiers of the one or more transmit chains.

Aspect 15: The method according to any of Aspects 12-14, further comprising predicting a temperature associated with the one or more transmit chains based on the at least one temperature prediction parameter, wherein the one or more transmit chains are configured based on the predicted temperature.

Aspect 16: The method according to any of Aspects 12-15, wherein configuring the one or more transmit chains comprises at least one of configuring a duty cycle associated with the signal transmission, configuring a bandwidth associated with the signal transmission, configuring a transmission power associated with the signal transmission, or selecting an amplifier to be used for the signal transmission.

Aspect 17: The method according to any of Aspects 12-16, wherein the waveform is orthogonal with a waveform for communication traffic from the UE.

Aspect 18: The method according to any of Aspects 12-17, further comprising receiving an allocation of one or more resources for transmitting the waveform, wherein the waveform is transmitted via the one or more resources.

Aspect 19: The method according to any of Aspects 12-18, wherein detecting the at least one temperature prediction parameter comprises solving one or more non-linear equations to identify a non-linearity associated with the one or more transmit chains using a trained machine learning model.

Aspect 20: An apparatus for wireless communication at a network entity, comprising: a memory; and one or more processors coupled to the memory and configured to: receive a representation of a waveform transmitted from a user equipment (UE); detect at least one temperature prediction parameter associated with one or more transmit chains of the UE based on the received representation of the waveform; identify a configuration of the UE to perform a signal transmission based on the at least one temperature prediction parameter; and output an indication of the configuration.

The above description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim.

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the methods and apparatus described above without departing from the scope of the claims.

1. A method for wireless communication at a network entity, comprising:
receiving a representation of a waveform transmitted from a user equipment (UE);
detecting at least one temperature prediction parameter associated with one or more transmit chains of the UE based on the received representation of the waveform;
identifying a configuration of the UE to perform a signal transmission based on the at least one temperature prediction parameter; and
outputting an indication of the configuration.

2. The method of claim 1, wherein identifying the configuration of the UE comprises allocating one or more resources to the UE to perform the signal transmission.

3. The method of claim 1, wherein the waveform includes a frequency-modulated continuous wave (FMCW) waveform or an orthogonal frequency-division multiplexing (OFDM) waveform.

4. The method of claim 1, wherein the at least one temperature prediction parameter comprises a parameter indicating a non-linearity associated with one or more amplifiers of the one or more transmit chains.

5. The method of claim 1, further comprising predicting a temperature associated with the one or more transmit chains based on the at least one temperature prediction parameter, wherein the configuration is identified based on the predicted temperature.

6. The method of claim 5, further comprising configuring a digital twin representing the one or more transmit chains of the UE based on the at least one temperature prediction parameter, wherein the temperature associated with the one or more transmit chains when the waveform was being transmitted is predicted using the digital twin.

7. The method of claim 1, wherein identifying the configuration comprises at least one of identifying a duty cycle associated with the signal transmission, identifying a bandwidth associated with the signal transmission, identifying a transmission power associated with the signal transmission, or selecting an amplifier to be used for the signal transmission.

8. The method of claim 1, wherein the waveform is orthogonal with a waveform for communication traffic from the UE.

9. The method of claim 1, further comprising allocating one or more resources for transmitting the waveform.

10. The method of claim 1, further comprising configuring a first base station and a second base station to receive the signal transmission based on the configuration of the UE.

11. The method of claim 1, wherein detecting the at least one temperature prediction parameter comprises solving one or more non-linear equations to identify a non-linearity associated with the one or more transmit chains using a trained machine learning model.

12. A method for wireless communication at a user equipment (UE), comprising:
transmitting a waveform via a first antenna;
receiving the waveform via a second antenna;
detecting at least one temperature prediction parameter associated with one or more transmit chains based on the received waveform;
configuring the one or more transmit chains based on the at least one temperature prediction parameter; and
performing a signal transmission via the one or more configured transmit chains.

13. The method of claim 12, wherein the waveform includes a frequency-modulated continuous wave (FMCW) waveform or an orthogonal frequency-division multiplexing (OFDM) waveform.

14. The method of claim 12, wherein the at least one temperature prediction parameter comprises a parameter indicating a non-linearity associated with one or more amplifiers of the one or more transmit chains.

15. The method of claim 12, further comprising predicting a temperature associated with the one or more transmit chains based on the at least one temperature prediction parameter, wherein the one or more transmit chains are configured based on the predicted temperature.

16. The method of claim 12, wherein configuring the one or more transmit chains comprises at least one of configuring a duty cycle associated with the signal transmission, configuring a bandwidth associated with the signal transmission, configuring a transmission power associated with the signal transmission, or selecting an amplifier to be used for the signal transmission.

17. The method of claim 12, wherein the waveform is orthogonal with a waveform for communication traffic from the UE.

18. The method of claim 12, further comprising receiving an allocation of one or more resources for transmitting the waveform, wherein the waveform is transmitted via the one or more resources.

19. The method of claim 12, wherein detecting the at least one temperature prediction parameter comprises solving one or more non-linear equations to identify a non-linearity associated with the one or more transmit chains using a trained machine learning model.

20. An apparatus for wireless communication at a network entity, comprising:
a memory; and
one or more processors coupled to the memory and configured to:
receive a representation of a waveform transmitted from a user equipment (UE);
detect at least one temperature prediction parameter associated with one or more transmit chains of the UE based on the received representation of the waveform;
identify a configuration of the UE to perform a signal transmission based on the at least one temperature prediction parameter; and
output an indication of the configuration.
